(19) United States
(12) Patent Application Publication
(10) Pub. No.: US 2024/0109148 A1
(43) Pub. Date: Apr. 4, 2024

(54) METAL PACKERS

(71) Applicant: Christopher Cockrill, Aberdeen (GB)

(72) Inventor: Christopher Cockrill, Aberdeen (GB)

(73) Assignee: Vertice Oil Tools Inc., Stafford, TX (US)

(21) Appl. No.: 18/388,056

(22) Filed: Nov. 8, 2023

Related U.S. Application Data
(63) Continuation of application No. PCT/EP22/67929, filed on Jun. 29, 2022.

(30) Foreign Application Priority Data
Jun. 30, 2021 (GB) 2109418.0
Jul. 3, 2022 (GB) 2203139.7

(51) Int. Cl. B23K 15/00; B23K 35/00; B23K 35/30

(52) U.S. Cl. CPC B23K 15/0073; B23K 15/0093; B23K 35/004; B23K 35/3033; B23K 2103/05

(57) ABSTRACT

A weld joint and method of welding a joint in parts subject to expansion in use. The weld joint is between dissimilar steel alloys and a weldable nickel-base shim is located between faces of the steel alloys prior to welding by an electron beam. Embodiments of an expandable metal sleeve and a metal packer for use as an isolation barrier in a well, are described which include the weld joint.

### BACKGROUND INFORMATION

### Field of the Disclosure

The present invention relates to apparatus and method for securing a tubular within another tubular or borehole, creating a seal across an annulus in a well bore, centralising or anchoring tubing within a wellbore using a metal packer. In particular, the invention relates to a weld joint and method of welding a joint in parts subject to expansion in use which into the chamber and cause the sleeve to move radially outwards and morph against the inner diameter of the larger diameter structure. The sleeve undergoes plastic deformation and, if morphed to a generally cylindrical metal structure, the metal structure will undergo elastic deformation to expand by a small percentage as contact is made. When the pressure is released the metal structure returns to its original dimensions and will create a seal against the plastically deformed sleeve. During the morphing process, both the inner and outer surfaces of the sleeve will take up the shape of the surface of the wall of the cylindrical structure. The packer thus creates a morphed isolation barrier.

### Background

A known problem in the construction of such metal packers is in the fixing of the ends of the cylindrical metal sleeve to the tubular body as this requires the mating of two cylindrical surfaces to each other. Additionally, the materials will be different as the sleeve will be formed from a more ductile material than the material of the tubular body as the sleeve must expand while the tubular body remains rigid. A stainless steel body and steel alloy sleeve are the preferred materials.

FIG. 1 schematically illustrates a prior art metal packer A, having a tubular body B and sleeve C, in half-longitudinal cross-section. In order to affix the sleeve C to the body B, connectors D are used. The connectors D are formed of a less ductile material than the material of the sleeve and may be formed of the same material as the tubular body B. To manufacture, the sleeve C is welded E,F onto the connector D. This assembly is then located on the body B with o-ring seals G located therebetween. The connectors D may be fixed to the body B by screw threaded portions on each, by locating screws F through the connector D into the body B and by welding H. This arrangement is difficult to weld and the weld joints may break when the sleeve is expanded.

U.S. Pat. No. 9,863,208 discloses a metal isolation barrier in which the tubular body is formed in one or more sections so that annular planar faces are created for abutment and circumferential butt welding between the sleeve member and the tubular body. This removes the requirement for connectors and reduces the time of construction.

GB2577341 describes a method of manufacturing an assembly for use as an isolation barrier to be run in and secured within a well. The assembly has a first tubular section providing a mandrel portion over which a sleeve body is located. The sleeve body is initially welded to a second tubular section to provide a part assembly which can be welded, inspected and machined without affecting the mandrel portion. The second tubular section is then coupled to the first tubular section and the sleeve body welded to the first tubular section to provide a chamber between the sections and the sleeve body. In use, fluid can enter the chamber through a port in the mandrel portion and morph the sleeve against a larger diameter surface in the well. In an embodiment the second tubular section includes a support for the sleeve body during initial welding which is then machined away.

In each of these arrangements, each weld joint is between materials of differing ductility and the weld joint is subject to expansion, in use. The welding of dissimilar materials can result in the creation of a martensite microstructure at the joint which is needle-like giving the joint a brittle behavior. While this does not cause an issue in static structures, there is a force placed on the weld joints in the metal packers during expansion. The expansion can be on one side of the weld joint, see FIG. 2(a) or across the entire weld joint as in FIG. 3(a). The stress, modelled in FIGS. 2(b) and 3(b), and strain, modelled in FIGS. 2(c) and 3(c), experienced at the weld joint could, under certain circumstances, cause the joint to fail. As the expansion occurs once the packer is installed, the weld joint cannot be tested for this vulnerability.

U.S. Pat. No. 6,489,583 describes a method of electron beam (e-beam) welding a joint between superalloy materials by inserting a shim of nickel-base superalloy in the joint and heating the superalloys with an electron beam. Superalloys contain about 50% or more by weight of nickel and are used in aircraft and industry gas turbine components. These superalloys such as Rene N5 are generally viewed as unweldable, so the technique provides a joint of two parts of the same superalloy material by adding a nickel rich shim between the two parts. This increases the fatigue life of the joint. The materials used in metal packers are not superalloys and the weld needs to be made across two different materials.

US2019/084085 describes a welding method for welding a cast iron (first member) and a steel (second member) having a lower hardness than the cast iron, which comprises: a first step for inserting an insert material (third member) having a lower hardness than the steel between the cast iron and the steel; a second step for welding the boundary portion between the cast iron and the insert material; and a third step for welding the boundary portion between the steel and the insert material. By creating a weld joint on either side of the insert material, improved strength characteristics are formed after welding. Additionally, a third pass across the joint in the centre of the insert material can be used to heat treat the material. Different welding techniques are taught for the passes of the first and second steps. At least two welds are required at each side of the insert with the insert material having sufficient width for a third heat treating pass to be made between the two welds on the insert material. This method is for improving strength in arrangements subject to thermal expansion as opposed to the expansion under pressure experienced during morphing in a packer.

### SUMMARY

It is an object of the present invention to provide a weld joint between two dissimilar steel alloys which obviates or mitigates one or more disadvantages of the prior art.

It is a further object of at least one embodiment of the present invention to provide a metal packer which obviates or mitigates one or more disadvantages of the prior art.

It is an object of at least one embodiment of the present invention to provide a method of assembling a metal packer which obviates or mitigates one or more disadvantages of the prior art.

According to a first aspect of the present invention there is provided a weld joint for parts subject to expansion in use, comprising:
a first part comprising a first steel alloy, the first part having a first face of a first surface area;
a second part comprising a second steel alloy, the second part having a second face of a second surface area;
the first steel alloy being dissimilar from the second steel alloy; a weldable nickel-base shim, inserted between the first and second faces, and characterised in that:
the first and second faces are electron beam welded together with the nickel-based shim being entirely consumed to form a weld metal composition of the weld joint as the first and second parts are fused together.

By dissimilar we mean that the two steel alloys have different chemical and mechanical properties. The expansion is a physical expansion by a force and not thermal expansion.

In this way, the weld metal composition will have properties more favourable to expansion than a weld metal composition of only the first and second steel alloy materials. This is because a weld metal composition which could be martensitic in microstructure and hence be more brittle can be moved to more austenitic in microstructure which shows a higher ductility for expansion by the addition of the nickel.

Preferably the first steel alloy is a low carbon alloy steel. More preferably the first steel alloy is 4130 or 4130m low carbon alloy steel. Preferably the second steel alloy is a stainless steel. More preferably the second steel alloy is 316 stainless steel or 316L stainless steel. Preferably the weldable nickel-base shim is an inconel alloy. More preferably the weldable nickel-base shim is 625 inconel alloy. In this way, the weld metal composition will be more austenite compared with the martensite tendencies of the low carbon alloy steel.

Preferably the weldable nickel-base shim is dimensioned to fill an overlap of the first and second faces when brought together in a butt joint. In this way, the entire area of the joint is filled with the shim material and hence a more uniform weld metal composition is formed.

Preferably there is a backer under the joint to ensure penetration through the entire length of the shim. The backer may be formed of the first steel alloy or the second steel alloy. The backer may be a separate part or may be formed integrally with the first or second part as per the respective steel alloy. In this way, the backer may form part of a structure subject to expansion as shown in FIG. 2(a). Alternatively the backer may be temporary, whether as a separate part or integrally, which is removed to leave part of a subject to expansion as shown in FIG. 3(a).

Preferably the weldable nickel-base shim has a thickness in the range 0.01 to 1.0 mm arranged between the first and second faces. More preferably, the weldable nickel-base shim has a thickness of 0.1 to 0.8 mm. The weldable nickel-base shim may have a thickness of 0.2 to 0.6 mm. The thickness may be selected on the basis of the dimensions of the electron beam together with the surface area of the faces.

Preferably, the first part is a first tubular body and the first face is a first annular face, the first annular face being in a plane perpendicular to a central axis of the first tubular body; the second part is a second tubular body and the second face is a second annular face, the second annular face being in a plane perpendicular to a central axis of the second tubular body; the first and second tubular bodies arranged to abut the first and second annular faces, with the first annular face entirely overlapping the second annular face; and the weldable nickel-base shim being an annular ring, dimensioned to fit between the abutted first and second annular faces and entirely covering the region of overlap. In this way cylindrical sections of dissimilar steel alloys can be butt welded end to end.

Preferably, the first and second annular faces have the same first annulus inner diameter and first annulus outer diameter with the first surface area equal to the second surface area, and the annular ring of the weldable nickel-base shim also has the first annulus inner diameter and first annulus outer diameter. In this way, the first and second faces and the shim completely overlap each other.

In a first weld joint, the first tubular body has a first body outer diameter and a first body inner diameter, the backer is formed from the first part, being a third tubular body extending from the first annular face, the third tubular body having a third body outer diameter equal to the first annulus inner diameter and a third body inner diameter equal to the first body inner diameter, with the first body outer diameter being equal to the first annulus outer diameter. In this way the second tubular body can slide over the third tubular body for the first and second annular faces to meet, with the third annular body acting as the backer at the electron beam weld.

In a second weld joint, the second tubular body has a second body outer diameter and a second body inner diameter, the backer is formed from the second part, being a fourth tubular body extending from the second annular face, the fourth tubular body having fourth body outer diameter equal to the first annulus inner diameter and a fourth body inner diameter equal to the second body inner diameter, with the second body outer diameter being equal to the first annulus outer diameter, and the backer is temporary. In this way the first tubular body can slide over the fourth tubular body for the first and second annular faces to meet, with the fourth annular body acting as a temporary backer at the electron beam weld. The second tubular body can then be machined to remove the temporary backer and make the second body inner diameter match the first annulus inner diameter, to provide a single tubular body comprising the two dissimilar materials circumferentially butt welded together end to end. The second part may be made of the less hard material and thus may be easier to machine.

Preferably, the first part is a section of a packer tubular body and the second part is a packer expandable sleeve. Preferably, the second weld joint is formed with the first tubular body having a fastening means on an inner surface; the first weld joint is then formed between a further first part and the second part of the second weld joint, the third tubular body having at least one port therethrough and a mating fastening means at a second end distal to the first tubular body; and the fastening means mating to join the first part and further first part together to provide a metal packer.

According to a second aspect of the present invention there is provided a method of welding a joint in parts subject to expansion in use, the method comprising the steps:
(a) providing a first part comprising a first steel alloy, the first part having a first face of a first surface area;
(b) providing a second part comprising a second steel alloy, the second steel alloy being dissimilar to the first steel alloy, the second part having a second face of a second surface area;
(c) bringing the first and second faces together and inserting a weldable nickel-base shim between the first and second faces;
(d) using an electron beam to form a weld metal composition which entirely consumes the weldable nickel-base shim as the first and second parts are fused together to create a weld joint between the first and second parts; and
(e) applying force on at least one side of the weld joint to cause the second part to expand relative to the first part.

In this way, dissimilar materials in which one has a higher ductility than the other can be welded together in a joint which can be made more ductile by increasing the nickel content of the weld metal composition. To join stainless steel to a steel alloy, electron beam (e-beam) welding has been found to be the most appropriate as the low heat input to the workpiece noticeably minimises distortion of the weld joint and the high level vacuum that can be achieved is advantageous over conventional arc welding.

Preferably, at step (d) the first and second parts are fused together on a single pass of the electron beam. Thus the electron beam is used to form the weld as opposed to heat treating which may be seen in the prior art.

Preferably the method includes the step of locating a backer under the joint before step (d). This ensures melting of the entire shim across the full length and width of the weld joint.

The method may include the step of removing the backer before step (e). In this way, the force can be applied across both sides of the weld joint.

Preferably, the first part is a first tubular element and the second part is a second tubular element, the method providing a structure having a first weld joint between the first part and the second part. Preferably, the method further comprises repeating the steps (a) to (d) before step (e) for a first part being a second tubular element and the second part being the structure having the first weld joint, to provide a tubular expansion sleeve of the second steel alloy having first and second ends of the first steel alloy wherein the second steel alloy is more ductile than the first steel alloy.

Preferably, the first part is a first section of a tubular body of a metal packer and the second part is a tubular expansion sleeve of the metal packer, the method providing a structure having a first weld joint between the tubular body and tubular expansion sleeve.

Preferably, the method further comprises repeating the steps (a) to (d) before step (e) for a further first part being a second section of the tubular body and the second part being the structure having the first weld joint, to create a second weld joint and provide a metal packer having a tubular body with a tubular expansion sleeve.

Preferably, the method includes the step of machining a larger inner diameter to the structure to remove the backer formed integrally with the second part on the first weld joint.

Preferably, the method includes sealing the backer integrally formed with the further first part to the first section of the structure. Preferably also, the first section and the second section of the tubular body are fastened together. This may be by complimentary screw threads or pins.

Preferably, at step (e) the force is applied by fluid flow though a port in the tubular body to a chamber created between the tubular body and the tubular expansion sleeve.

In the description that follows, the drawings are not necessarily to scale. Certain features of the invention may be shown exaggerated in scale or in somewhat schematic form, and some details of conventional elements may not be shown in the interest of clarity and conciseness. It is to be fully recognized that the different teachings of the embodiments discussed below may be employed separately or in any suitable combination to produce the desired results.

Accordingly, the drawings and descriptions are to be regarded as illustrative in nature, and not as restrictive. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. All numerical values in this disclosure are understood as being modified by “about”. All singular forms of elements, or any other components described herein including (without limitations) components of the apparatus are understood to include plural forms thereof.

### BRIEF DESCRIPTION OF THE DRAWINGS

Embodiments of the present invention will now be described, by way of example only, with reference to the accompanying drawings of which:

FIG. 1 is a cross-sectional view through a metal packer according to the prior art;

FIG. 2(a) illustrates the expansion points across a weld joint according to the prior art, with FIG. 2(b) being the modelled stress and FIG. 2(c) being the modelled strain, on the weld joint of FIG. 2(a);

FIG. 3(a) illustrates the expansion points across a further weld joint according to the prior art, with FIG. 3(b) being the modelled stress and FIG. 3(c) being the modelled strain, on the weld joint of FIG. 3(a);

FIG. 4 is a schematic illustration of a cross-sectional view through a weld joint according to an embodiment of the present invention;

FIG. 5 is a Schaeffler diagram indicating weld materials and compositions;

FIGS. 6(a)-(e) illustrate steps in forming an expandable metal sleeve member for a packer according to an embodiment of the present invention;

FIGS. 7(a)-(c) are cross-sectional views through a metal packer according to an embodiment of the present invention; and

FIGS. 8(a) and 8(b) are schematic illustrations of a metal packer according to an embodiment of the present invention, in an (a) unset and (b) set configuration in an open borehole.

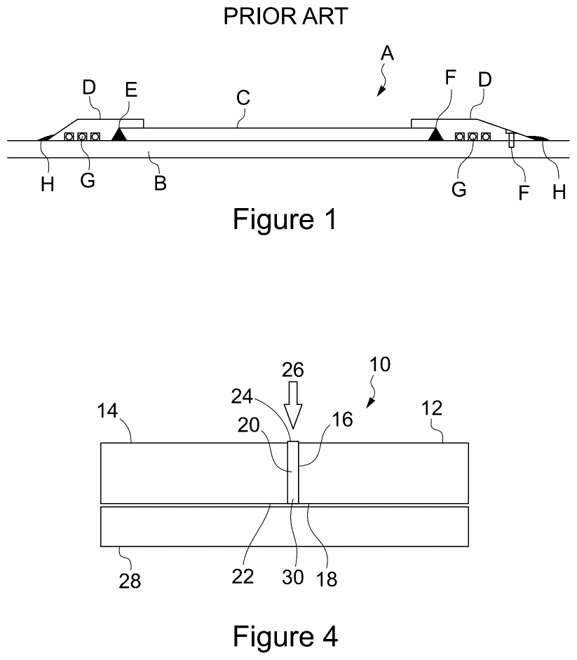

### DETAILED DESCRIPTION

Reference is initially made to FIG. 4 of the drawings which illustrates a weld joint, generally indicated by reference numeral 10, between a first part 12 comprising a first steel alloy and a second part 14 comprising a second steel alloy. The first steel alloy is dissimilar from the second steel alloy in that they have different chemical and mechanical properties. The first part 12 has a first face 16 of a first surface area at a first end 18. The second part 14 has a second face 20 of a second surface area at a second end 22. The first and second parts 12,14 are arranged end to end with the faces 16,20 overlapping in a butt weld arrangement. Inserted between the faces 16,20 is a weldable nickel-base shim 24. In a preferred embodiment the dimensions of the surface areas of the faces 16,20 is substantially the same as each other and the shim 24. The shim 24 has a uniform thickness between the faces 16,20. An electron beam weld 26 is made at the interface so as to melt the shim 24 with the steel alloys on either face 16,20 and create a weld metal composition 30 at the weld joint 10. The shim 24 is entirely consumed as the faces 16,20 are fused together.

The electron beam 26 serves to heat the joint 10 to be welded. Electron-beam welding is a fusion welding process in which a beam of high-velocity electrons is applied to materials to be joined. The workpieces melt and flow together as the kinetic energy of the electrons is transformed into heat upon impact. As would be apparent to those of ordinary skill in the art, any known electron beam source could be used, and the invention is not meant to be limited to a particular structural configuration. Moreover, apparatus for generating the electron beam 26 for performing electron beam welding is known and need not be further described. Electron beam welding is selected as, depending on the joint thickness and the type of base metal, the low total heat input to the workpiece can noticeably minimise distortion of the weld joint. The high-level vacuum that can be achieved also offers advantages over conventional arc welding processes in providing more uniformity across the weld joint.

Under the joint 10 is located a backer 28. Backer 28 is any material which will absorb the heat generated by the electron beam 26 and allow the electron beam 26 to penetrate to a depth greater than the thickness of the joint so that the entire shim 24 melts and thus forms a weld over the entire length and breadth of the surface areas of the faces 16,20.

For a metal packer, it is known to choose a more ductile metal for the sleeve as this must exhibit expansion under pressure while the body of the packer must remain unaffected. Note that the expansion is created by a force and not by thermal expansion. The first steel alloy is selected as a low carbon steel alloy and more particularly 4130, which is quenched and tempered chrome-molybdenum low alloy steel, having no nickel content. This is an ideal material for the tubular body of a packer. The second steel alloy is stainless steel and more particularly 316L stainless steel. 316L is more ductile and is used for the sleeve in a packer. The two materials would be considered dissimilar due to differences in chemical and mechanical properties.

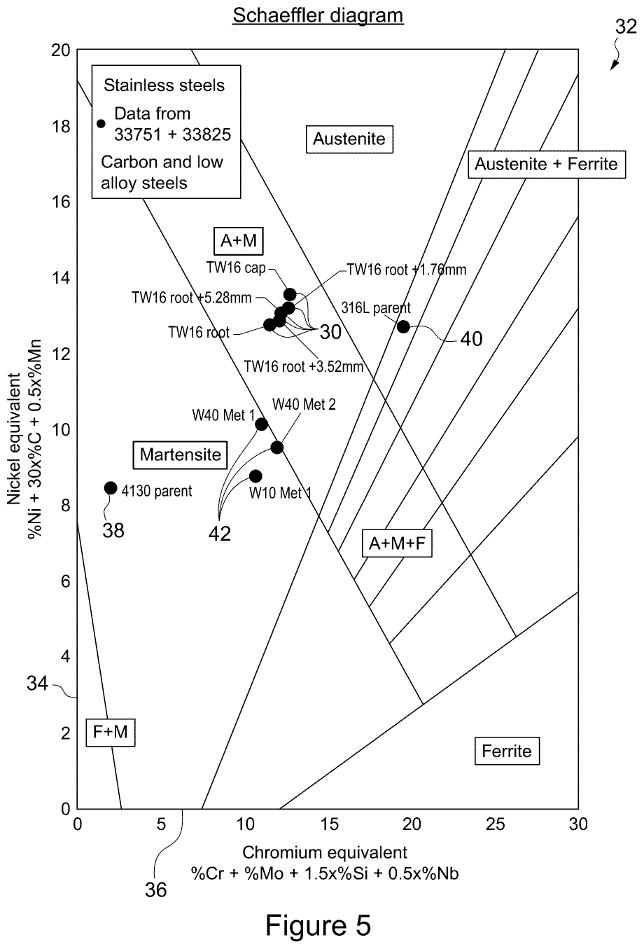

Whether two dissimilar metals or alloys can be successfully welded depends on the physical properties of the metals, such as melting point, thermal conductivity, atomic size and thermal expansion. The Schaeffler diagram is an empirical description of the microstructures of the weld metal that result from welding different compositions. This type of diagram has been used for many years to predict the cast or weld metal microstructures in conventional austenitic and other stainless steels. FIG. 5 illustrates a Schaeffer diagram 32 in which the nickel equivalent 34 calculated from the weight percentages of austenite-forming elements (C, Ni, Mn, Cu, N) is plotted against the chromium equivalent 36 calculated from the weight percentage of ferrite-forming elements (Cr, Si, Mo, Nb, W) and gives the proportions of martensite (M), austenite (A), and ferrite (F) in the resulting microstructure, shown in areas of the diagram.

Using parent material certificates and semi-quantitative EDX analysis, the microstructure across the weld regions in a prior art electron beam weld between 4130 parent and 316L parent was determined. These regions are: 4130 parent, 4130 HAZ, Weld, 316L HAZ and the 316L parent. The results are plotted in FIG. 5. 4130 parent 38 is martensite, 316L parent 40 is austenite while the mixture of materials forming the prior art weld metal composition 42 has a predominantly martensitic microstructure. Martensite microstructure are needle-like and lead to brittle behaviour of materials and is formed by very high cooling rates.

By introducing a nickel alloy to the weld joint 10, the weld metal composition 30 can be modified. In the present invention, a pre-placed shim of nickel alloy, such as 625 Inconel, is used. The shim provides a nickel-enriched austenitic weld metal microstructure which is more resistant to the forms of cracking seen in martensite materials and reduces brittleness so that the weld joint 10 can expand when put under pressure. A weld composition 30 with this nickel-enrichment is indicated on FIG. 5. Depending on the dimensions of the faces 16, 20, the thickness of the shim is selected to ensure that it contributes sufficiently to the weld composition 30 while being entirely consumed in a single pass of the electron beam when forming the weld joint 10. Suitable shim thicknesses between the faces 16,20 are in the range 0.01 to 1.0 mm, though more preferably between 0.2 to 0.6 mm.

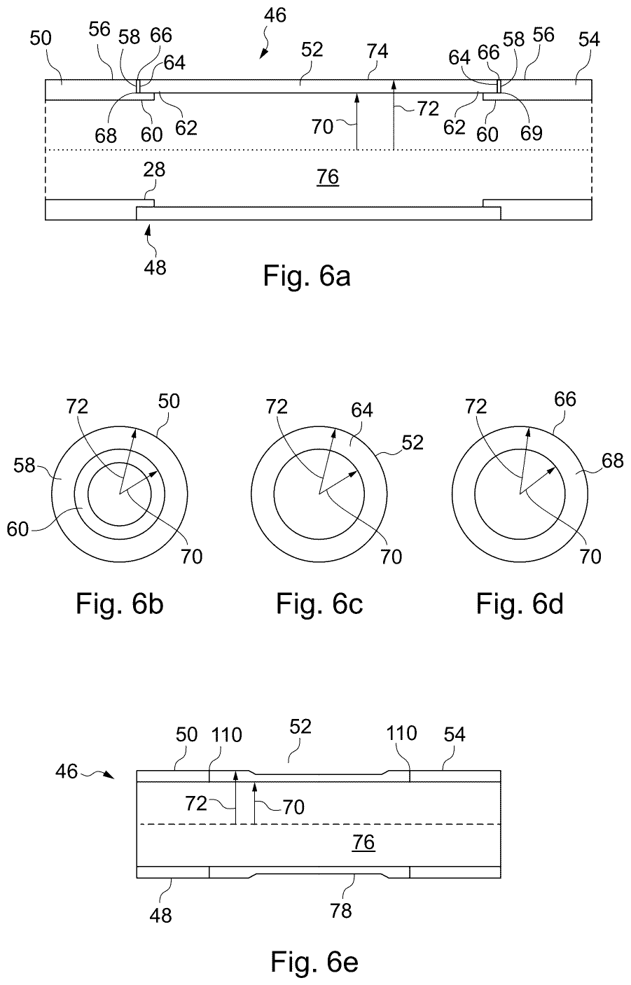

Reference is now made to FIGS. 6(a)-(e) which illustrate forming an expandable metal sleeve member 46 for a packer according to an embodiment of the present invention. At FIG. 6(a), the sleeve member 46 includes a sleeve body 48 of tubular form comprising a first sleeve end 50, a central sleeve section 52 and a second sleeve end 54. In this embodiment, the first sleeve end 50 and the second sleeve end 52 are identical. The first sleeve end 50 and the second sleeve end 52 are formed of a first material. At a first end 56, each sleeve end 50,54 is provided with annular surface 58 around the circumference of sleeve end 50,54 with a shelf 60 projecting towards the central sleeve section 52. The shelf 60 may be considered as a tubular body extending from the annular surface 58. See FIG. 6(b) for an end view. The central sleeve section 52 is formed of a second material and terminates at each end 62 in an annular face 64. See FIG. 6(c) for an end view.

To assemble the sleeve body 48, a shim 66 being a thin annular disc with identical end faces 68,69 see FIG. 6(d), is slid over each end 56 along the shelf 60. The end faces 68,69 will abut the annular surfaces 58, respectively. The end sleeve sections 50,54 are then brought together with the central section 52 such that each central section end 62 slides upon a shelf 60. Each central section end face 64 abuts against an end face 68,69 of the shim 66, respectively. As seen from FIGS. 6(b)-6(d), the annular faces 58,64,68,69 have substantially the same inner 70 and outer 72 diameters. A substantially even outer surface 74 is formed across the contiguous sleeve sections 50,52,54. Abutting annular faces 58,64,68,69 are then welded together using e-beam welding, with the shoulder 60 acting as the backer 28, formed integrally with the end sections 50,52, to create welded joints 110. The inner bore 76 can then be machined to remove the shoulders 60 to create a single sleeve member body 48 which is a continuous cylindrical unit, see FIG. 6(e). The end sleeve sections 50,54 appear to be butt-welded to the central section 52 via the weld joints 110 with shims 66. Note that each e-beam weld is achieved on a single pass around the packer which is sufficient to fuse the faces and the shim abutted to them, to create a weld composition at the weld joint.

By forming the sleeve body 48 of sections of different materials, in this case five different sections formed of three different materials, the expandable sleeve 46 can be constructed from material sections which have different material properties from one another but which act together under expansion to prevent failure at any adjoining region. In this case, the first material, forming the central section 52, is formed typically from a 316L or Alloy 28 grade steel, but it could be any other suitable metal which undergoes elastic and plastic deformation when pressure is applied to it. Ideally the first material exhibits high ductility, that is, high strain before failure and thus a higher degree of expandability than the second material. The second material, which forms the first and second end sleeve sections 50,54 will be less ductile, higher gauge steel than the first material, such as 4130 grade steel. The third material forms the shims 66 and is a nickel-based alloy such as Inconel 625 to increase the ductility of the joints 110 and prevent fracture on expansion. The shim 66 is of narrow width, typically 0.4 mm, for a sleeve thickness of 8-9 mm. However, it may be increased depending on materials and sleeve dimensions.

Selecting a first material which is more expandable than the second material, the multi material sleeve body can be formed such that it responds to fluid pressure in a manner which causes the morph against the inner surface of the large diameter structure to occur more swiftly and such that a more secure seal is formed. The introduction of a third material assists in preventing discontinuities between the first and second materials having a detrimental effect on expansion of the sleeve when it is subject to pressure. In welding the sections 50,66,52,66,54 together as a unit, prior to the assembly of the sleeve member 46 on a tubular body, the sleeve member 46 can undergo quality control surveying and assessment, including x-ray of welds 110 without interference from other parts of a tubular assembly.

An embodiment of a machined sleeve 46 is shown in FIG. 6(e) wherein the central section 52 has a recess 78 formed in the outer surface 74 such that the wall thickness is thinner in the recessed region 78 than along the remaining sleeve body 48. By removing thickness from the wall of the central section 52, the ability of the sleeve member 46 to expand across this section is increased. Thus, the thinner walled central portion 78 will, upon the application of fluid pressure, morph while the ends 50,52 are unaffected and remain principally in their original shape, with the weld joints 110 providing continuity between the sections during expansion.

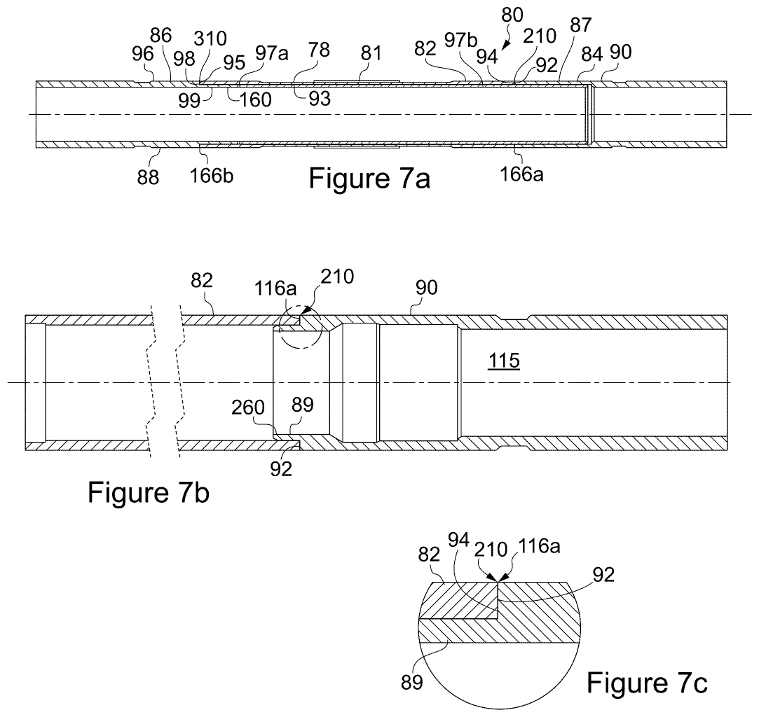

Reference is initially made to FIG. 7(a) of the drawings which illustrates a metal packer, generally indicated by reference numeral 80, for use as an isolation barrier manufactured according to an embodiment of the present invention. A packer expandable sleeve 82 of a first material, is located between a first section 84 and a second section 86 of a packer tubular body 88, of a second material, by weld joints 210,310 including a shim 166a,166b according to the present invention. The first section 84 has a first tubular body 90 and an annular end face 92 with dimensions which match the first annular end face 94 of the sleeve 82. The second section 86 has a second tubular body 96 with an annular end face 98. A third tubular body 99 extends from the annular end face 98 to form a shoulder 160, upon which the expandable sleeve 82 is located. The third tubular body 99 extends along the packer and into the first tubular body 90, where it is connected thereto. The second annular end face 95 of the sleeve 82 is dimensioned to match the annular end face 98. Ports 97a,b in the third tubular body allow for the introduction of fluid to a chamber 93 between the sleeve 82 and third tubular body 99, to expand the sleeve 82. The sleeve 82 and first material is 316L stainless steel. The packer tubular body 88 and second material is 4130 steel alloy. The shims 166a,b are formed of an annealed nickel alloy being 625 Inconel.

In construction, referring to FIG. 7(b), the first tubular body 90 has a portion with a decreased internal diameter to provide a fourth tubular body 89 extending from the annular end face 92 acting as a shoulder 260. The first tubular body 90 and the sleeve 82 have substantially the same outer diameter. A shim 166a, being an annular ring having the same dimensions as the annular end face 92 at the shoulder 260 with a thickness of 0.2 mm thickness is slid over the fourth tubular body 89 until it bottoms out on the shoulder 260 against face 92. The sleeve 82 is then located over the fourth tubular body 89 for the first annular face 94 to abut the shim 166a.

Ensuring there are no gaps, the weld joint 210 is formed by an e-beam to give a circumferential butt weld, as shown in FIG. 7(c). The fourth tubular body 89 acts a backer to the weld joint 210. The inner bore 115 of the first section 84 and sleeve 82 is machined to increase the inner diameter so as to remove the fourth tubular body 89. The weld joint 210 can be inspected at this time.

Returning to FIG. 7(a), a shim 166b, being an annular ring having the same dimensions as the annular end face 98 at the shoulder 160 with a thickness of 0.2 mm thickness is slid over the second tubular body 96 until it bottoms out on the shoulder 160 against face 98. The sleeve 82 is then located over the third tubular body 99 for the second annular face 95 to abut the shim 166b. The third tubular body 99 is sealed to the first tubular body 90 in the bore 115. The weld joint 310 is formed by an e-beam to give a circumferential butt weld to affix the expandable sleeve 82 to the packer tubular body 88.

The packer 80 can then have a final machine finish to bring the outer surface 87 at the weld joints 210,310 down to a desired outer diameter. A typical diameter for packer 80 is 118 mm. Screw threads can be machined into the ends of the packer body 88 to provide the known pin and box sections for connecting the packer 80 in a string. Following a final inspection, the packer 80 is now ready for use as a morphable isolation barrier.

The expandable sleeve 82 has a recess 78 as described hereinbefore with reference to FIG. 6(e). The expandable sleeve 82 may be provided with a non-uniform outer surface 81 such as ribbed, grooved or other keyed surface in order to increase the effectiveness of the seal created by the sleeve body 82 when secured within another casing section or borehole.

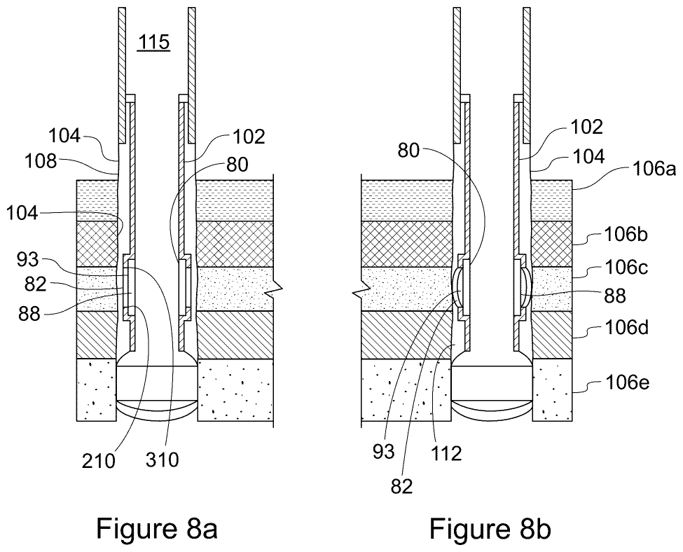

Reference will now be made to FIGS. 8(a)-(b) of the drawings which provides an illustration of a method for setting the packer 80 within a well bore to provide an isolation barrier. Like parts to those in FIGS. 7(a)-(c) have been given the same reference numerals to aid clarity. In use, the packer 80 is conveyed into the borehole by any suitable means, such as incorporating the packer 80 into a casing or liner string 102 and running the string into the wellbore 104 until it reaches the location within the open borehole 106 at which operation of the packer 80 is intended. This location is normally within the borehole at a position where the sleeve body 82 is to be expanded in order to, for example, isolate the section of borehole 106b located above the sleeve 82 from that below 106d in order to provide an isolation barrier between the zones 106b, 106d. While only a single packer 80 is shown on the string 102, further assemblies may be run on the same string 102 so that zonal isolation can be performed in a zone 106 in order that an injection, frac'ing or stimulation operation can be performed on the formation 106a-e located between two sleeves.

Each sleeve 82 can be set by increasing the pump pressure in the throughbore 115 to a predetermined value which represents a pressure of fluid at the ports 97 being sufficient to morph the sleeve 82. This morphed pressure value will be calculated from knowledge of the diameter of packer 80, the approximate diameter of the borehole 106 at the sleeve 82, the length of the sleeve 82, the material properties of the sleeve and thickness of the sleeve 82. The morphed pressure value is the pressure sufficient to cause the sleeve 82 to move radially away from the mandrel body 88 by elastic expansion, contact the surface 108 of the borehole and morph to the surface 108 by plastic deformation.

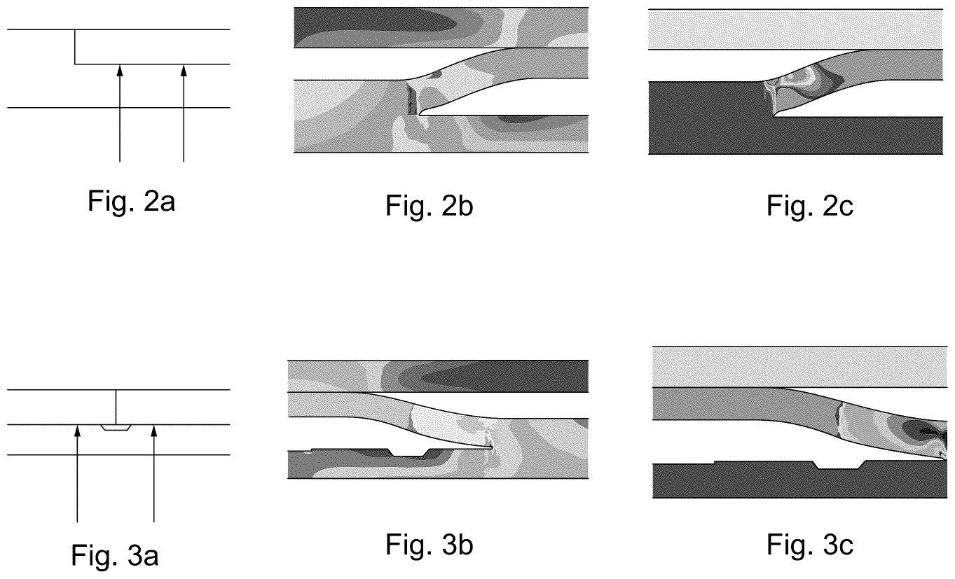

Check valves are arranged to allow fluid from the throughbore 115 to enter the chamber 93. This fluid will increase pressure in the chamber 93 and against the inner surface of the sleeve 82 so as to cause the sleeve 82 to move radially away from the mandrel body 88 by elastic expansion, contact the surface 104 of the borehole and morph to the surface 104 by plastic deformation. On expansion, the lower weld joint 210 experiences a force across the entire weld joint, as per FIG. 3(a) while the upper weld joint 310 experiences force from a single side, as per FIG. 2(a). When the morphing has been achieved, the check valves will close and trap fluid at a pressure equal to the morphed pressure value within the chamber 93.

As illustrated in FIG. 8(b), the sleeve 82 will have taken up a fixed shape under plastic deformation with the inner surface matching the profile of the surface 108 of the borehole 106, and the outer surface also matching the profile of the surface 108 to provide a seal which effectively isolates the annulus 112 of the borehole 106 above the sleeve 82 from the annulus 110 below the sleeve 82. If two assemblies are set together then zonal isolation can be achieved for the annulus between the sleeves. At the same time the sleeves have effectively centred, secured and anchored the tubing string 102 to the borehole 106.

The principle advantage of the present invention is that it provides a weld joint for parts subject to expansion in use which are formed from two dissimilar metals.

A further advantage of the present invention is that it provides a method of welding a joint in parts subject to expansion in use which are formed from dissimilar metals.

A yet further advantage of at least one embodiment of the present invention is that it provides a metal packer in which the expansion of the sleeve is less susceptible to potential failure at the weld joints.

It will be apparent to those skilled in the art that modifications may be made to the invention herein described without departing from the scope thereof. For example, while a metal packer is described the weld joints of the present invention could be used on other downhole parts subject to expansion in use, such as expandable liners and casing. The end faces need not be exactly perpendicular to the central longitudinal axis but may be tapered or of any profile which matches that of the opposing face.

1. A weld joint for parts subject to expansion in use, comprising:
a first part comprising a first steel alloy, the first part having a first face of a first surface area;
a second part comprising a second steel alloy, the second part having a second face of a second surface area;
the first steel alloy being dissimilar from the second steel alloy;
a weldable nickel-base shim, inserted between the first and second faces,
and characterised in that:
the first and second faces are electron beam welded together with the nickel-based shim being entirely consumed to form a weld metal composition of the weld joint as the first and second parts are fused together.

2. A weld joint according to claim 1 wherein the first steel alloy is a low carbon alloy steel and the second steel alloy is a stainless steel.

3. A weld joint according to claim 2 wherein the first steel alloy is 4130 low carbon alloy steel, the second steel alloy is 316L stainless steel and the weldable nickel-base shim is 625 inconel alloy.

4. A weld joint according to claim 1, wherein the weldable nickel-base shim is dimensioned to fill an overlap of the first and second faces when brought together in a butt joint.

5. A weld joint according to claim 1, wherein there is a backer under the joint, the backer being formed of the first steel alloy.

6. A weld joint according to claim 5 wherein the backer is formed integrally with the first part.

7. A weld joint according to claim 1, wherein the weldable nickel-base shim has a thickness in the range 0.01 to 1.0 mm, arranged between the first and second faces.

8. A weld joint according to claim 7 wherein the weldable nickel-base shim has a thickness in the range 0.2 to 0.6 mm, arranged between the first and second faces.

9. A weld joint according to claim 1, wherein the first part is a first tubular body and the first face is a first annular face, the first annular face being in a plane perpendicular to a central axis of the first tubular body; the second part is a second tubular body and the second face is a second annular face, the second annular face being in a plane perpendicular to a central axis of the second tubular body; the first and second tubular bodies arranged to abut the first and second annular faces, with the first annular face entirely overlapping the second annular face; and the weldable nickel-base shim being an annular ring, dimensioned to fit between the abutted first and second annular faces and entirely covering the region of overlap.

10. A weld joint according to claim 9 wherein the first and second annular faces have the same first annulus inner diameter and first annulus outer diameter with the first surface area equal to the second surface area, and the annular ring of the weldable nickel-base shim also has the first annulus inner diameter and first annulus outer diameter.

11. A weld joint according to claim 9, wherein in a first weld joint the first tubular body has a first body outer diameter and a first body inner diameter, the backer is formed from the first part, being a third tubular body extending from the first annular face, the third tubular body having a third body outer diameter equal to the first annulus inner diameter and a third body inner diameter equal to the first body inner diameter, with the first body outer diameter being equal to the first annulus outer diameter.

12. A weld joint according to any one of claim 9, wherein in a second weld joint, the second tubular body has a second body outer diameter and a second body inner diameter, the backer is formed from the second part, being a fourth tubular body extending from the second annular face, the fourth tubular body having fourth body outer diameter equal to the first annulus inner diameter and a fourth body inner diameter equal to the second body inner diameter, with the second body outer diameter being equal to the first annulus outer diameter, and the backer is temporary.

13. A weld joint according to claim 12 wherein the temporary backer is removed and the second body inner diameter matches the first annulus inner diameter, to provide a single tubular body comprising the two dissimilar materials circumferentially butt welded together end to end.

14. A weld joint according to claim 1, wherein the first part is a section of a packer tubular body and the second part is a packer expandable sleeve.

15. A weld joint according to claim 14 wherein the second weld joint is formed with the first tubular body having a fastening means on an inner surface; the first weld joint is then formed between a further first part and the second part of the second weld joint, the third tubular body having at least one port therethrough and a mating fastening means at a second end distal to the first tubular body; and the fastening means mating to join the first part and further first part together to provide a metal packer.

16. A method of welding a joint in parts subject to expansion in use, the method comprising the steps:
(a) providing a first part comprising a first steel alloy, the first part having a first face of a first surface area;
(b) providing a second part comprising a second steel alloy, the second steel alloy being dissimilar to the first steel alloy, the second part having a second face of a second surface area;
(c) bringing the first and second faces together and inserting a weldable nickel-base shim between the first and second faces;
(d) using an electron beam to form a weld metal composition which entirely consumes the weldable nickel-base shim as the first and second parts are fused together to create a weld joint between the first and second parts; and
(e) applying force on at least one side of the weld joint to cause the second part to expand relative to the first part.

17. A method of welding a joint according to claim 16 wherein includes the step of locating a backer under the joint before step (d).

18. A method of welding a joint according to claim 17 wherein the method includes the step of removing the backer before step (e).

19. A method of welding a joint according to claim 18 wherein the first part is a first tubular element and the second part is a second tubular element, the method providing a structure having a first weld joint between the first part and the second part as a circumferential butt weld.

20. A method of welding a joint according to claim 19 wherein the method further comprises repeating the steps (a) to (d) before step (e) for a first part being a second tubular element and the second part being the structure having the first weld joint, to provide a tubular expansion sleeve of the second steel alloy having first and second ends of the first steel alloy wherein the second steel alloy is more ductile than the first steel alloy.
